(19) United States
(12) Patent Application Publication
(10) Pub. No.: US 2016/0051438 A1
(43) Pub. Date: Feb. 25, 2016

(54) STIMULATION DEVICE

(71) Applicants: Meike HAHR, Hamburg (DE); Till MUHL, Hamburg (DE)

(72) Inventors: Meike HAHR, Hamburg (DE); Till MUHL, Hamburg (DE)

(73) Assignee: Ovo Joint Venture, LLC, Hightstown, NJ (US)

(21) Appl. No.: 14/426,306

(22) PCT Filed: Sep. 6, 2012
(86) PCT No.: PCT/EP2012/067452

§ 371 Date: Nov. 12, 2015

(51) Int. Cl. A61H 19/00; A61H 23/02

(52) U.S. Cl. CPC A61H 19/44; A61H 23/0263; A61H 19/40

(57) ABSTRACT

Disclosed is a stimulation device comprising a first arm (2) having a proximal end portion (2a) and a distal end portion (2b) and a second arm (4) having a proximal end portion (4a) and a distal end portion (4b), wherein the first arm (2) and the second arm (4) are connected with each other at their respective proximal end portion (2a, 4a) so as to form an essentially U- or V-shaped arrangement with the distal end portions (2a, 4a) of the first and second arms (2, 4) being spaced from each other so that the first arm (2) is adapted to be inserted into a vagina and the second arm (4) is adapted to get, essentially at the same time, into contact with a body portion outside the vagina. According to the present invention there is provided a third (6) arm having a proximal end portion (6a) and a distal end portion (6b) and connected at its proximal end portion (6a) with the proximal end portion (2a; 4a) of the first arm (2)and/or the second arm (4), wherein the third arm (6) extends in an essentially opposite direction with regard to the orientation of the first arm (2) and/or the second arm (4) and is adapted to be inserted into a sexual organ.

The present invention relates to a stimulation device comprising a first arm having a proximal end portion and a distal end portion and a second arm having a proximal end portion and a distal end portion, wherein the first arm and the second arm are connected with each other at their respective proximal end portion so as to form an essentially U- or V-shaped arrangement with the distal end portions of the first and second arms being spaced from each other so that the first arm is adapted to be inserted into a vagina and the second arm is adapted to get, essentially at the same time, into contact with a body portion outside the vagina.

A stimulation device having the aforementioned configuration as disclosed e.g. in EP 1 477 149 A1 is widely known in the prior art for a long time.

There are different types of stimulation devices having the aforementioned configuration, which types differ in function and shape. For instance, there are so-called passive stimulation devices which do not create any vibrations or rotational movements, whereas so-called active stimulation devices are designed to create vibrations and/or rotational movements in at least one of their arms. Further, there are rigid stimulation devices, or there are stimulation devices wherein at least one of their arms is flexible or elastic. Moreover, there are stimulation devices whose arms have similar dimensions, in particular are of similar length and/or thickness or diameter, whereas there are also stimulation devices whose first arm forms a long and thick inner arm and whose second arm forms a short and thin outer arm.

Preferably but not exclusively, the present invention focuses upon a particular type of stimulation device which is called “rabbit” vibrator whose first arm is a vibrating and rotating shaft made in the shape of a phallus and whose second arm forms a clitoral stimulator attached to the shaft of the first arm. The name “rabbit” is derived from the fact that the second arm forming the clitoral stimulator looks like a pair of rabbit ears when this type of stimulation device appeared on the market in the 1990s. Rabbit vibrators are designed to give more intense sensations than the more traditional dildo or clitoral stimulator, since they are provided for simultaneous internal (vaginal) and external (clitoral) stimulation.

It is an object of the present invention to improve a stimulation device having the aforementioned configuration so as to expand its application possibilities in order to be used for different pleasure in accordance with the user's current needs and, thus, to give more fun.

In order to achieve the above and further objects, according to the present invention, there is provided a stimulation device comprising a first arm having a proximal end portion and a distal end portion and a second arm having a proximal end portion and a distal end portion, wherein the first arm and the second arm are connected with each other at their respective proximal end portion so as to form an essentially U- or V-shaped arrangement with the distal end portions of the first and second arms being spaced from each other so that the first arm is adapted to be inserted into a vagina and the second arm is adapted to get, essentially at the same time, into contact with a body portion outside the vagina, characterized by a third arm having a proximal end portion and a distal end portion and connected at its proximal end portion with the proximal end portion of the first arm and/or the second arm, wherein the third arm extends in an essentially opposite direction with regard to the orientation of the first arm and/or the second arm and is adapted to be inserted into a vagina as well.

According to the present invention, in addition to the U- or V-shaped arrangement formed by the first and second arms, there is provided a third arm which is connected at its proximal end portion with said U- or V-shaped arrangement in the region of the proximal end portions of the first and second arms where the junction of the proximal end portions of the first and second arms with each other is provided. The device according to the present invention can be used in different operational modes. In a first operational mode, the device can be used like a conventional “rabbit” stimulator with the first arm to be inserted into the vagina and the second arm to be brought into contact or touch outside with the skin of a portion of a female human body, in particular in the area of the clitoris or directly with said organ for stimulation, wherein the third arm can be used as a handle. In a second operational mode, the third arm can be used a conventional dildo to be inserted into a sexual organ like the vagina, wherein the arrangement of the first and second arms can be used as a handle. Finally, the device according to the present invention can be used in a third operational mode which is a simultaneous combination of the first and second operational modes so that the device is used at the same time in both the first and second operational modes. So, the present invention provides a stimulation device which comprises a threefold function for different types of stimulation so that the stimulation device can be used for different pleasure in accordance with the user's current needs and, thus, gives more fun. A further advantage of the present invention is that the user needs to buy only one stimulation device instead of three different stimulation devices and therefore to pay only for one stimulation device rather than for three ones so that the present invention results in the saving of costs, too.

Further advantageous embodiments and modifications of the present invention are defined in the dependent claims.

In order to enhance stimulation, the third arm as well as at least one of the first and second arms each can preferably include vibration means. According to a modification of this embodiment, all the three arms each can include vibration means.

In a further modification of the aforementioned embodiment, which comprises switch means for activating, deactivating and controlling the vibration means, the switch means are arranged in the region of the connection of the proximal end portions of the three arms. Such a location allows an optimal access to the switch means for controlling the vibration means during use of the device in each of the aforementioned operational modes. Preferably the switch means can be arranged at least partly at the proximal end portion of the second arm. According to a still further preferred modification, the switch means can be arranged essentially in the middle between the distal end portions of the first arm and the third arm.

According to a still further modification of the aforementioned embodiment, the third arm further includes a battery for supplying the vibration means with electrical power.

In a further preferred embodiment, the first and second arms are oriented in the same first direction, wherein according to a modification of this embodiment the third arm is oriented in a second direction essentially opposite to the first direction.

It is still further preferred embodiment, the third arm is longer than the longest one of the first and second arms. Alternatively, the length of the third arm can be about twice of the length of the first arm.

The length of the second arm can be shorter than the length of the first arm for a more advantageous consideration of the anatomy of a human, in particular female, body.

In order to further simplify the construction of the stimulation device, the first, second and third arms may form an integral body. According to a still further preferred embodiment, at least the surface of all the three arms is at least partly made of soft silicone material, since such a material has the advantage to be soft, flexible and hygienic.

Further, the distal end portion of the second arm can comprise at least two fingers spaced from each other and arranged essentially side by side so that it has a shape in accordance with the “rabbit” style.

According to a further preferred embodiment, the first arm comprises a slightly curved shape wherein the curvature is oriented towards the second arm. Such a curved shape is advantageous for smoother insertion into the vagina and for the achievement of extra stimulation.

According to a still further preferred embodiment, the distal end portion of the second arm comprises a slightly curved shape wherein the curvature is oriented to the first arm. Such a curved shape brings more convenience to achieve optimal pleasure.

In order to better reach a pleasure point in different positions and for the user's individual current needs, the distal end portion of the second arm can be preferably flexible so that the distance of the distal end portion of the second arm to the first arm is variable.

Further, the third arm may preferably comprise a slightly curved shape which is advantageous for smoother insertion into the vagina and for the achievement of extra stimulation.

In the following, a preferred embodiment according to the present invention will be described with reference to the accompanying drawings in which:

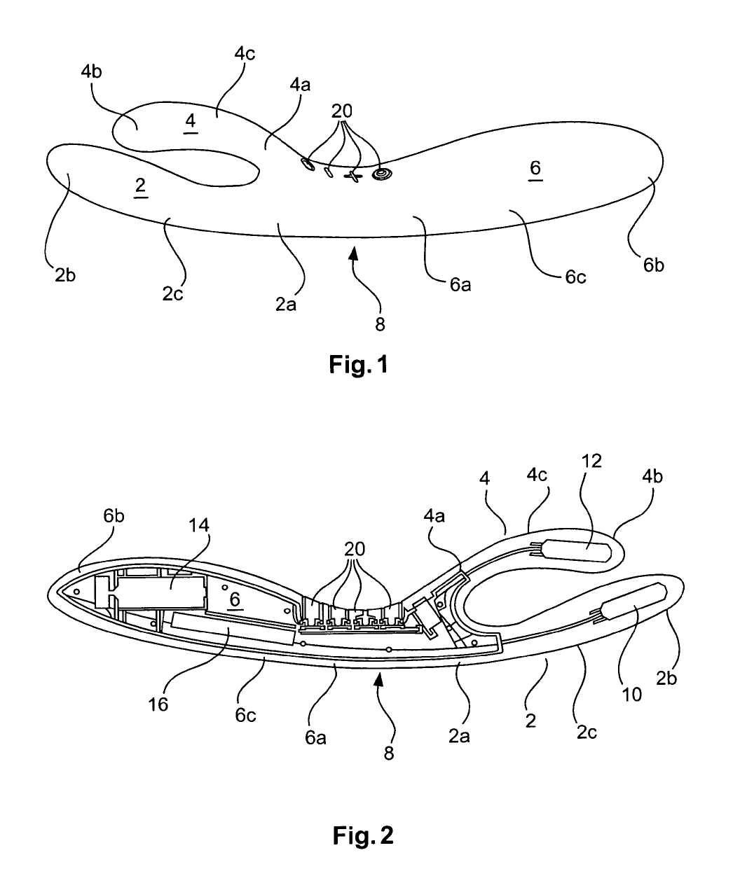

FIG. 1 is a perspective side view of a stimulation device according to preferred embodiment of the present invention; and

FIG. 2 is a longitudinal section through the device of FIG. 1.

FIGS. 1 and 2 show a stimulation device according to a preferred embodiment of the present invention. The device comprises an elongated first arm 2 having a proximal end portion 2a, a distal end portion 2b and an elongated middle section 2c between the proximal end portion 2a and the distal end portion 2b, and a second arm 4 having a proximal end portion 4a, a distal end portion 4b and an elongated middle section 4c between the proximal end portion 4a and the distal end portion 4b. As further shown in FIGS. 1 and 2, both the first and second arms 2, 4 are connected with each other at their respective proximal end portion 2a, 4a so as to form an essentially V-shaped arrangement wherein the first and second arms 2, 4 are oriented essentially in the same direction and the distal end portions 2b, 4b of the first and second arms 2, 4 are spaced from each other. However, both the first and second arms 2, 4 can alternatively be formed and/or the connection of both these arms 2, 4 at their respective proximal end portion 2a, 4a can alternatively be provided so as to form any other arrangement provided the distal end portions 2b, 4b of these arms 2, 4 are spaced from each other, e.g. like an essentially U-shaped arrangement.

In a first operational mode, the device with its aforementioned arrangement of the first and second arms 2, 4 can be used as a “rabbit” stimulator with the first arm 2 at its distal end portion 2b to be inserted into the vagina and the second arm 4 to be brought into contact or touch outside with the skin of a portion of a female human body, in particular in the region of the clitoris or directly with said organ for stimulation. Therefore, the aforementioned arrangement of the first and second arms 2, 4 can also be called a “rabbit” arrangement with the first arm 2 provided as inner arm and the second arm 4 provided as outer arm.

As further shown in the FIGS. 1 and 2, the first arm 2 comprises a slightly curved shape wherein the curvature is oriented towards the second arm 4, which is advantageous for smoother insertion into the vagina and for the achievement of extra stimulation, and the second arm 4 comprises a slightly curved shape wherein the curvature is oriented towards the first arm 2, which results in more convenience to achieve optimal pleasure.

As further shown in the FIGS. 1 and 2, the length of the second arm 4 is shorter than the length of the first arm 2.

For a better “rabbit” function and in order to better reach a pleasure point in different positions in accordance with the user's individual current needs, the distal end portion 4b of the second arm 4 is flexible so that the distance of the distal end portion 4b of the second arm 4 to the first arm 2 is variable.

Different from the shown embodiment according to FIG. 1, in an alternative embodiment not shown here, the distal end portion 4b of the second arm 4 can comprise two fingers spaced from each other so as to look as a pair of “rabbit” ears.

As further shown in the FIGS. 1 and 2, there is provided a third arm 6 having a proximal end portion 6a, a distal end portion 6b and an elongated middle section 6c between the proximal end portion 6a and the distal end portion 6b. The third arm 6 is connected at its proximal end portion 6a with the aforementioned V-shaped arrangement of the first and second arms 2, 4 in the region of their proximal end portions 2a, 4a so that this region defines a junction 8 of the proximal end portions 2a, 4a, 6a of the first, second and third arms 2, 4, 6 with each other. As further shown in the FIGS. 1 and 2, whereas the first and second arms 2, 4 are oriented essentially in the same first direction (to the left in FIG. 2 and to the right in FIG. 2), the third arm 6 is oriented in a second direction (to the right in FIG. 1 and to the left in FIG. 2) essentially just opposite to said first direction. Similar to the first arm 2, the third arm 6 comprises a slightly curved shape as well. In the shown embodiment, the third arm 6 is longer than each of the first and second arms 2, 4, wherein the length of the third arm 6 is about twice of the length of the first am 2.

Moreover, as it becomes clear in particular from FIG. 1, in the shown embodiment the first, second and third arms 2, 4, 6 form a common integral unit.

In the above mentioned first operational mode, wherein the device can be used as a “rabbit” stimulator, the third arm 6 can be used as a handle. However, the provision of the third arm 6 allows a second operational mode, wherein the third arm 6 can be used as a conventional dildo to be inserted into a sexual organ like the vagina, wherein the arrangement of the first and second arms 2, 4 can be used as a handle. Finally, the device according to the shown embodiment can be used in a third operational mode which is a simultaneous combination of the first and second operational modes so that the device is used at the same time in both the first and second operational modes.

In order to enhance stimulation, in the shown embodiment each of the three arms 2, 4, 6 includes a vibration means, wherein a first vibration means 10 is arranged within the distal end portion 2b of the first arm 2, a second vibration means 12 is arranged within the distal end portion 4b of the second arm 4 and a third vibration means 14 is arranged within the distal end portion 6b of the third arm 6. The third vibration means 14 preferably comprises a rotation ball head driven by a rotation motor (not shown) in order to subject the distal end portion 6b of the third arm 6 not only to vibrations but also to a rotational movement for maximal stimulation. Further, in the shown embodiment according to FIG. 2, for supplying all the vibration means 10, 12, 14 with electrical power, the third arm 6 additionally includes a battery 16 which is arranged essentially in the region of its middle section 6c.

For activating, deactivating and controlling the vibration means 10, 12, 14, switch means 20 are provided whose buttons are arranged, in the shown embodiment, at an outer side of the region of the junction 8, and hence, approximately in the middle between the distal end portions 2b, 6b of the first and third arms 2, 6, wherein the buttons of the switch means 20 are located at least partly at the proximal end portion 4a of the second arm 4. Such a location allows an optimal access to the switch means 20 for controlling the vibration means 10, 12, 14 during use of the device in each of the aforementioned operational modes.

Moreover, the device includes a control unit (not shown in the figures) for a separate control of each of the vibration means 10, 12, 14. So, via the switch means 20 in corporation with said control unit the user is able to select, among the vibration means 10, 12, 14, the vibration means which is needed to operate. Of course, the control unit is provided to select and control more than one vibration means at the same time. In particular, the switch means 20 may comprise e.g. a selection button for selecting the vibration means to operate, a program button for selecting a certain vibration program and an intensity button for adjusting the intensity of the vibrations.

Finally, it should be noted that at least partly the surface of the device and preferably the whole device is at least made of soft silicone material.

1. A stimulation device comprising a first arm (2) having a proximal end portion (2a) and a distal end portion (2b) and a second arm (4) having a proximal end portion (4a) and a distal end portion (4b), wherein the first arm (2) and the second arm (4) are connected with each other at their respective proximal end portion (2a, 4a) so as to form an essentially U- or V-shaped arrangement with the distal end portions (2a, 4a) of the first and second arms (2, 4) being spaced from each other so that the first arm (2) is adapted to be inserted into a vagina and the second arm (4) is adapted to get, essentially at the same time, into contact with a body portion outside the vagina,
characterized by a third (6) arm having a proximal end portion (6a) and a distal end portion (6b) and connected at its proximal end portion (6a) with the proximal end portion (2a; 4a) of the first arm (2)and/or the second arm (4), wherein the third arm (6) extends in an essentially opposite direction with regard to the orientation of the first arm (2) and/or the second arm (4) and is adapted to be inserted into a sexual organ.

2. The device according to claim 1, wherein the third arm (6) and at least one of the first and second arms (2, 4) each includes vibration means (10, 12, 14).

3. The device according to claim 2, further comprising switch means (20) for activating, deactivating and controlling the vibration means (10, 12, 14), wherein the switch means (20) are arranged essentially in the region of connection (8) of the proximal end portions (2a, 4a, 6a) of the three arms (2, 4, 6).

4. The device according to claim 3, wherein the switch means (20) are arranged at least partly at the proximal end portion (4a) of the second arm (4).

5. The device according to claim 3 or 4, wherein the switch means (20) are arranged essentially in the middle between the distal end portions (2a, 6a) of the first arm (2) and the third arm (6).

6. The device according to at least any one of the claims 2 to 5, wherein all the three arms (2, 4, 6) each include vibration means (10, 12, 14).

7. The device according to at least any one of the claims 2 to 6, wherein the third arm (6) further includes a battery for supplying the vibration means (10, 12, 14) with electrical power.

8. The device according to at least any one of the preceding claims, wherein the first and second arms (2, 4) are oriented essentially in the same first direction.

9. The device according to claim 8, wherein the third arm (6) is oriented in a second direction essentially opposite to the first direction.

10. The device according to at least any one of the preceding claims, wherein the third arm (6) is longer than the longest one of the first and second arms (2, 4).

11. The device according to at least any one of the claims 1 to 9, wherein the length of the third arm (6) is about twice of the length of the first arm (2).

12. The device according to at least any one of the preceding claims, wherein the second arm (4) is shorter than the first arm (2).

13. The device according to at least any one of the preceding claims, wherein the first, second and third arms (2, 4, 6) commonly form an integral body.

14. The device according to at least any one of the preceding claims, wherein at least the surface of all the three arms (2, 4, 6) is at least partly made of soft silicone material.

15. The device according to at least any one of the preceding claims, wherein the first arm (2) comprises a curved shape wherein the curvature is oriented towards the second arm (4).

16. The device according to at least any one of the preceding claims, wherein the distal end portion (4a) of the second arm (4) comprises a slightly shape wherein the curvature is oriented to the first arm (2).

17. The device according to at least any one of the preceding claims, wherein the distal end portion (4a) of the second arm (4) is flexible so that the distance of the distal end portion (4a) of the second arm (4) to the first arm (2) is variable.

18. The device according to at least any one of the preceding claims, wherein the third arm (6) comprises a curved shape.
